(19) United States
(12) Patent Application Publication
(10) Pub. No.: US 2012/0098160 A1
(43) Pub. Date: Apr. 26, 2012

(54) PROCESS FOR PRODUCING RESIN MOLDED ARTICLE

(75) Inventors: Kenji WATANABE, Ichihara-shi (JP); Tetsuro DOBASHI, Ichihara-Shi (JP)

(73) Assignee: SUMITOMO CHEMICAL COMPANY, LIMITED, Tokyo (JP)

(21) Appl. No.: 13/233,161

(22) Filed: Sep. 15, 2011

(30) Foreign Application Priority Data
Oct. 22, 2010 (JP) 2010-237122

(51) Int. Cl. B29C 45/00

(52) U.S. Cl. 264/328.18

(57) ABSTRACT

A process for producing a resin molded article, comprising steps of (1) plasticizing a resin composition containing an organic fiber and a thermoplastic resin with an injection-molding machine, (2) injecting the plasticized resin composition into a mold cavity of the injection-molding machine, and (3) pressure-holding against the resin composition in the mold cavity for a pressure-holding time of 0.5 to 60 seconds under holding-pressure of 70 to 300 MPa.

### FIELD OF THE INVENTION

The present invention relates to a process for producing a resin molded article.

### BACKGROUND OF THE INVENTION

In order to improve mechanical properties of a molded article of a thermoplastic resin, a fiber-containing thermoplastic resin is molded to produce an article, which is well known in the art. For example, JP 2008-6697A discloses a process for producing a molded article of a fiber-containing thermoplastic resin, comprising (i) measuring a plasticized fiber-containing thermoplastic resin under rotating a screw of a screw injection-molding machine, such that a measuring stroke is 50% or more of the largest injection stroke, (ii) injecting the measured plasticized fiber-containing thermoplastic resin into a mold cavity, (iii) solidifying the resin in the cavity, and (iv) taking the resultant molded article out of the cavity, characterized in that back pressure of the screw when measuring the plasticized fiber-containing thermoplastic resin can be changed to a predetermined value.

### SUMMARY OF THE INVENTION

Although the above production process is particularly preferable for producing a molded article of a glass fiber-containing thermoplastic resin, said production process is less preferable for producing a molded article of an organic fiber-containing thermoplastic resin, because the resultant molded article is insufficient in its impact strength.

In view of the above circumstances, an object of the present invention is to provide a process for producing a high-impact molded article of an organic fiber-containing thermoplastic resin.

The present invention is a process for producing a resin molded article, comprising steps of:
(1) plasticizing a resin composition containing an organic fiber and a thermoplastic resin with an injection-molding machine;
(2) injecting the plasticized resin composition into a mold cavity of the injection-molding machine; and
(3) pressure-holding against the resin composition in the mold cavity for a pressure-holding time of 0.5 to 60 seconds under holding-pressure of 70 to 300 MPa.

### DETAILED DESCRIPTION OF THE INVENTION

### [Organic Fiber]

An organic fiber used in the present invention may be an organic fiber known in the art. Examples of the organic fiber are a polyester fiber, a polyamide fiber, a polyurethane fiber, a polyimide fiber, a polyolefin fiber, a polyacrylonitrile fiber, a kenaf fiber, and a cellulose fiber. Among them, preferred is a polyester fiber.

Examples of a polyester for the polyester fiber are a polyester produced by reacting an alkylene glycol with an aromatic dicarboxylic acid, such as polyethylene terephthalate, polybutylene terephthalate, polyethylene naphthalate, and polybutylene isophthalate; a polyester produced by reacting terephthalic acid with 1,4-cyclohexanedimethanol; a polyester produced by a polycondensation reaction of a dicarboxylic acid (for example, maleic acid, phthalic acid and adipic acid) with a bisphenol A derivative produced by an addition reaction of ethylene oxide with each of two terminal hydroxyl groups of bisphenol A; and a wholly aromatic polyester produced by a polycondensation reaction of an aromatic dicarboxylic acid with an aromatic dihydroxyl compound and/or aromatic hydroxylcarboxylic acid, such as a condensation product of terephthalic acid with bisphenol A, and a condensation product of isophthalic acid with p-hydroxybenzoic acid. Among them, preferred is a polyester produced by reacting an alkylene glycol with an aromatic dicarboxylic acid, more preferred is a polyalkylene terephthalate or a polyalkylene naphthalene dicarboxylate, and further preferred is a polyalkylene naphthalene dicarboxylate.

The organic fiber in the present invention has single yarn fineness of preferably 1 dtex (decitex) or larger from a viewpoint of yarn-making stability, and 30 dtex or smaller from a viewpoint of interface strength between the organic fiber and the thermoplastic resin in the resin composition; and more preferably 1.5 dtex or larger from a viewpoint of dispersibility of the organic fiber in the resin composition, and 25 dtex or smaller from a viewpoint of impact strength of a resin molded article obtained.

The organic fiber contained in the resin composition in step (1) has number-average fiber length of preferably 1 mm or longer from a viewpoint of impact strength of a resin molded article obtained, and 50 mm or shorter from a viewpoint of moldability of the resin composition, and more preferably 3 to 30 mm.

The organic fiber used in the present invention is preferably treated with a binder. An amount of the binder adhering to the surface of the organic fiber is preferably 0.1 to 10 parts by weight, and more preferably 0.1 to 3 parts by weight, per 100 parts by weight of the organic fiber. Examples of the binder are a polyolefin resin, a polyurethane resin, a polyester resin, an acrylic resin, an epoxy resin, starch, plant oil, and a mixture of one or more thereof with an epoxy compound. Among them, preferred is a polyolefin resin or a polyurethane resin.

The resin composition in the present invention contains the organic fiber in an amount of preferably 1 to 70% by weight, and more preferably 5 to 60% by weight, and contains the after-mentioned thermoplastic resin in an amount of 30 to 99% by weight, and more preferably 40 to 95% by weight, provided that the total of the organic fiber and the thermoplastic resin is 100% by weight.

### [Thermoplastic Resin]

A thermoplastic resin used in the present invention may be a thermoplastic resin known in the art. Examples of the thermoplastic resin are an amide resin, a polyester resin, a styrene resin, an acrylic resin, a polyolefin resin, and a mixture of two or more thereof. Among them, preferred is a polyolefin resin.

Examples of the amide resin are nylon 6, nylon 46, nylon 66, nylon 11, nylon 12, nylon 6.10, and nylon 6.12. The amide resin may be an aromatic polyamide. Examples of the aromatic polyamide are an aromatic polyamide produced by polymerizing an aromatic amino acid such as 4-(aminomethyl)benzoic acid and 4-(aminoethyl)benzoic acid, and an aromatic polyamide produced by polymerizing an aromatic dicarboxylic acid with a diamine. Examples of the aromatic dicarboxylic acid are terephthalic acid and isophthalic acid. Examples of the diamine are hexamethylene diamine, undecamethylene diamine, dodecamethylene diamine, 2,2,4-trimethylhexamethylene diamine, 2,4,4-trimethylhexamethylene diamine, metaxylylene diamine, paraxylylene diamine, bis(4-aminocyclohexyl)methane, bis(4-aminocyclohexyl)propane, bis(3-methyl-4-aminocyclohexyl)methane, 1,3-bis(aminomethyl)cyclohexane, and 1,4-bis(aminomethyl)cyclohexane. An aromatic polyamide is preferably polyhexamethylene isophthalamide. The amide resin is preferably nylon 6, nylon 66 or and nylon 6.10.

The above polyester resin is preferably an aromatic polyester resin, and more preferably a polyester resin produced by polymerizing an aromatic dicarboxylic acid with an aliphatic glycol. Examples of the aromatic dicarboxylic acid are terephthalic acid, naphthalenedicarboxylic acid, isophthalic acid, diphenyl ketone dicarboxylic acid, and anthracene dicarboxylic acid. Examples of the aliphatic glycol are a polymethylene glycol having 2 to 10 carbon atoms such as ethylene glycol, trimethylene glycol, tetramethylene glycol, pentamethylene glycol, hexamethylene glycol, and decamethylene glycol; and an aliphatic diol such as cyclohexane dimethanol. The polyester resin is preferably polyethylene terephthalate, polybutylene terephthalate, polyethylene naphthalate or and polybutylene naphthalate.

Examples of the above styrene resin are a homopolymer of a styrene skeleton-containing monomer, and a copolymer of the styrene skeleton-containing monomer with one or more other monomers. An example of the styrene skeleton-containing monomer is a vinyl aromatic compound such as styrene; a nucleus-alkyl-substituted styrene (for example, o-methylstyrene, m-methylstyrene, p-methylstyrene, 2,4-dimethylstyrene, ethylstyrene and p-tert-butylstyrene); and an α-alkyl-substituted styrene (for example, α-methylstyren and α-methyl-p-methylstyren). Examples of the above other monomer are an alkyl ester of an unsaturated carboxylic acid such as an alkyl methacrylate (for example, methyl methacrylate, cyclohexyl methacrylate and isopropyl methacrylate), and an alkyl acrylate (for example, methyl acrylate, ethyl acrylate, butyl acrylate, 2-ethylhexyl acrylate, and cyclohexyl acrylate); an unsaturated carboxylic acid such as methacrylic acid, acrylic acid, itaconic acid, maleic acid, fumalic acid, and cinnamic acid; and an unsaturated dicarboxylic anhydride such as maleic anhydride and itaconic anhydride. The above copolymer contains a polymerization unit of the styrene skeleton-containing monomer in an amount of 50% by weight or more, and less than 100% by weight, provided that the total of the copolymer is 100% by weight. The styrene resin is preferably polystyrene, poly(α-methylstyrene), a styrene-methyl methacrylate copolymer, a styrene-methyl acrylate copolymer or a styrene-maleic anhydride copolymer.

An example of the above acrylic resin is a resin containing 50 to 100% by weight of a polymerization unit of acrylic acid, a derivative of acrylic acid, methacrylic acid, a derivative of methacrylic acid, or a combination of two or more thereof, provided that the total of the resin is 100% by weight. An example of the derivative of acrylic acid is an acrylic ester such as methyl acrylate, ethyl acrylate, butyl acrylate, isopropyl acrylate, and 2-ethylhexyl acrylate. An example of the derivative of methacrylic acid is a methacrylic ester such as cyclohexyl methacrylate, tert-butylcyclohexyl methacrylate, and methyl methacrylate. The acrylic resin is preferably polyacrylic acid, polymethacrylic acid, poly-methyl acrylate or polymethyl methacrylate.

Examples of the above polyolefin resin are a homopolymer of a monomer such as ethylene, propylene and an α-olefin having 4 to 12 carbon atoms; a copolymer of two or more of those monomers; a mixture of two or more of those homopolymers; a mixture of two or more of those copolymers; and a mixture of one or more of those homopolymers with one or more of those copolymers. Specific examples of the polyolefin resin are an ethylene homopolymer; a propylene homopolymer; a propylene-ethylene random copolymer; a propylene-α-olefin random copolymer; a propylene-ethylene-α-olefin random copolymer; and a polymer produced by polymerizing propylene to form a propylene homopolymer, and then copolymerizing ethylene with propylene in the presence of the propylene homopolymer to further form an ethylene-propylene copolymer. Although the above finally-exemplified polymer is often referred to as a “propylene block copolymer” by those skilled in the art, the polymer is not a true block copolymer as seen in a textbook on polymers, but substantially a mixture of the propylene homopolymer with the ethylene-propylene copolymer. Among them, preferred is a propylene block copolymer from a viewpoint of heat resistance of a resin molded article obtained. Examples of the above α-olefin having 4 to 12 carbon atoms are 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecene. Among them, preferred is an α-olefin having 4 to 8 carbon atoms, such as 1-butene, 1-pentene, 1-hexene and 1-octane.

### [Modifier]

The resin composition in the present invention may contain a modifier such as a modified polyolefin resin. The “modified polyolefin resin” in the present invention means a resin produced by modifying an olefin homopolymer or an olefin copolymer containing two or more kinds of olefin polymerization units with an unsaturated carboxylic acid and/or unsaturated carboxylic acid derivative, which is referred to hereinafter as an “unsaturated carboxylic acid and/or its derivative”, or means a resin produced by copolymerizing one or more olefins with an unsaturated carboxylic acid and/or its derivative. Specific examples of the modified polyolefin resin are following modified polyolefin resins (1) to (4) and a combination of two or more thereof:
(1) a modified polyolefin resin produced by grafting an unsaturated carboxylic acid and/or its derivative onto an olefin homopolymer;
(2) a modified polyolefin resin produced by grafting an unsaturated carboxylic acid/or its derivative onto an olefin copolymer of two or more olefins;
(3) a modified polyolefin resin produced by grafting an unsaturated carboxylic acid and/or its derivative onto an olefin block copolymer, wherein the olefin block copolymer can be produced by a method similar to that for the above “propylene block copolymer”, namely, by a method comprising steps of (i) polymerizing an olefin, thereby forming an olefin homopolymer, and (ii) copolymerizing two or more olefins in the presence of the olefin homopolymer; and
(4) a modified polyolefin resin produced by copolymerizing one or more olefins with one or more unsaturated carboxylic acids/or their derivatives.

Examples of the above unsaturated carboxylic acid are maleic acid, fumalic acid, itaconic acid, acrylic acid, and methacrylic acid. Examples of the above unsaturated carboxylic acid derivative are an acid anhydride of the above unsaturated carboxylic acid, an ester thereof, an amide thereof, an imide thereof, and a metal salt thereof, such as maleic anhydride, itaconic anhydride, methyl acrylate, ethyl acrylate, butyl acrylate, glycidyl acrylate, methyl methacrylate, ethyl methacrylate, butyl methacrylate, 2-hydroxyethyl methacrylate, glycidyl methacrylate, monoethyl maleate, diethyl maleate, monomethyl fumarate, dimethyl fumarate, acrylamide, methacrylamide, a monoamide of maleic acid, diamide of maleic acid, a monoamide of fumaric acid, maleimide, N-butylmaleimide, and sodium methacrylate. Among them, preferred is acrylic acid, glycidyl methacrylate, maleic anhydride, or 2-hydroxyethyl methacrylate.

The unsaturated carboxylic acid used for producing above modified polyolefin resins (1) to (3) can be replaced with a compound such as citric acid and malic acid, which undergoes a dehydration reaction under a graft reaction condition to change to an unsaturated carboxylic acid.

The above modified polyolefin resin may be a commercially-available modified polyolefin resin, such as MODIPER (trade name) manufactured by NOF Corporation; BLEMMER CP (trade name) manufactured by NOF Corporation; BONDFAST (trade name) manufactured by Sumitomo Chemical Co., Ltd.; BONDINE (trade name) manufactured by Sumitomo Chemical Co., Ltd.; REXPEARL (trade name) manufactured by Japan Polyethylene Corporation; ADMER (trade name) manufactured by Mitsui Chemicals, Inc.; MODIC AP (trade name) manufactured by Mitsubishi Chemical Corporation; POLYBOND (trade name) manufactured by Chemtura Corporation; and YUMEX (trade name) manufactured by Sanyo Chemical Industries, Ltd.

The above modified polyolefin resin contains a polymerization unit of an unsaturated carboxylic acid and/or its derivative in an amount of preferably 0.1 to 20% by weight, from a viewpoint of improved mechanical strength of the modified polyolefin resin, such as impact strength, durability and stiffness, provide that the total of the modified polyolefin rein is 100% by weight. The amount can be determined based on a characteristic absorption of the polymerization unit found in an IR or NMR spectrum.

Examples of a method for producing above modified polyolefin resins (1) to (3) area solution method, a bulk method, a melt-kneading method, and a combined method of two or more thereof, which are disclosed in a document such as “Practical Polymer Alloy Designing” authored by Humio IDE, published by Kogyo Chosakai Publishing Co., Ltd. (1996); Prog. Polym. Sci., 24, 81-142 (1999); JP 2002-308947A; JP 2004-292581A; JP 2004-217753A; and JP 2004-217754A. The above modified polyolefin resin (4) can be produced by a high-pressure radical polymerization method, a solution polymerization method, or an emulsion polymerization method.

### [Other Component]

The resin composition in the present invention may contain one or more of the below-exemplified components, as long as the above-mentioned object of the present invention is not inhibited: inorganic fillers such as talc, mica, clay, calcium carbonate, aluminum hydroxide, magnesium hydroxide, wollastonite, barium sulfate, silica, calcium silicate, and potassium titanate; antioxidants such as phenol series antioxidants, thioether series antioxidants and organic phosphorus series antioxidants; thermal stabilizers such as hindered amine series thermal stabilizers; ultraviolet absorbing agents such as benzophenone series ultraviolet absorbing agents, benzotriazole series ultraviolet absorbing agents, and benzoate series ultraviolet absorbing agents; antistatic agents such as nonion series antistatic agents, cation series antistatic agents, and anion series antistatic agents; dispersing agents such as bisamide series dispersing agents, wax series dispersing agents, and organic metallic salt series dispersing agents; lubricants such as amide series lubricants, wax series lubricants, organic metallic salt series lubricants, and ester series lubricants; decomposition agents such as oxide series decomposition agents and hydrotalcite series decomposition agents; metal deactivators such as hydrazine series metal deactivators and amine series metal deactivators; flame retardants such as bromine-containing organic flame retardants, phosphoric acid series flame retardants, antimony trioxide, magnesium hydroxide, and red phosphorus; crystal nucleating agents such as organic phosphoric acid series crystal nucleating agents and sorbitol series crystal nucleating agents; pigments such as organic pigments and inorganic pigments; organic fillers; and antibacterial agents such as inorganic antibacterial agents and organic antibacterial agents.

### [Production of Resin Composition]

The resin composition in the present invention can be produced by following method (A), (B) or (C), among which preferred is method (C) from a viewpoint of (i) ease of its production, and (ii) mechanical strength such as impact strength of a resin molded article obtained from the resin composition:
(A) a method comprising steps of (i) mixing respective starting materials at one time, thereby obtaining a mixture, and (ii) melt-kneading the mixture;
(B) a method comprising steps of (i) mixing respective starting materials step-wise, thereby obtaining a mixture, and (ii) melt-kneading the mixture; and
(C) a pultrusion method.

The mixing in each step (i) of above methods (A) and (B) can be carried out with an apparatus such as a Henschel mixer, a ribbon blender and a blender. The melt-kneading in each step (ii) of above methods (A) and (B) can be carried out with an apparatus such as a Banbury mixer, PLASTOMILL, a BRABENDER plastograph, and an extruder (for example, mono-axial extruder and double screw extruder).

Above pultrusion method (C), which itself is well known in the art, comprises impregnating a continuous fiber bundle with a resin. Specific examples of method (C) in the present invention are following methods (C1) to (C3):
(C1) a method comprising steps of (i) passing a continuous fiber bundle through an impregnating vessel containing an emulsion, suspension or solution of a resin in a solvent, thereby impregnating the continuous fiber bundle with the emulsion, suspension or solution, and then (ii) removing the solvent contained therein;
(C2) a method comprising steps of (i) spraying a continuous fiber bundle with a powdery resin, or passing a continuous fiber bundle through a vessel containing a powdery resin, thereby adhering the powdery resin to the continuous fiber bundle, and then (ii) melting the resin, thereby impregnating the continuous fiber bundle with the resin; and
(C3) a method comprising a step of passing a continuous fiber bundle through a crosshead, and concurrently therewith, supplying a melted resin to the crosshead from an extruder, thereby impregnating the continuous fiber bundle with the resin.

Among them, preferred is method (C3). The crosshead used in method (C3) is preferably a crosshead disclosed in JP 3-272830A.

The above impregnation in methods (C1) to (C3) is carried out one time, or two or more times (repeatedly). A resin composition produced by pultrusion method (C) can be used in combination with a resin composition produced by above melt-kneading method (A) or (B).

The resin composition in the present invention is not particularly limited in its shape, and has preferably a pellet-shape, namely, the resin composition in the present invention is preferably a pellet. The resin composition pellet has longitudinal length of preferably 1 to 50 mm, more preferably 3 to 20 mm, and particularly preferably 5 to 15 mm, in order to (i) fill an injection-mold cavity easily with the pellets, and (ii) obtain a resin molded article having high strength. When the longitudinal length is less than 1 mm, the resin molded article may be insufficient in its impact strength, and when the longitudinal length is more than 50 mm, the pellet may be difficult-to-form.

Longitudinal length of the above resin composition pellet produced by pultrusion method (C) is the same as length of the organic fiber contained in the resin composition pellet. The term “the same” means that the organic fiber has number-average length of 90 to 110% of the longitudinal length of the resin composition pellet. Therefore, the number-average length of the organic fiber is equal to the longitudinal length of the pellet, and is preferably 1 to 50 mm, more preferably 3 to 20 mm, and particularly preferably 5 to 15 mm. The organic fibers contained in the resin composition pellet are arranged preferably in parallel to one another.

The above number-average length of organic fibers contained in the pellet is measured by a method comprising steps of:
(1) separating organic fibers contained in pellets by soxhlet extraction by use of a solvent such as xylene;
(2) choosing a suitable amount of the organic fibers from the separated organic fibers;
(3) dispersing the chosen organic fibers homogeneously in a liquid such as water, provided that the liquid is used in an amount of 1,000 times or more the weight of the chosen organic fibers, thereby obtaining a dispersion liquid;
(4) isolating one portion of the dispersion liquid, provided that the isolated portion contains 0.1 to 2 mg of the organic fibers;
(5) filtering off the organic fibers contained in the isolated portion;
(6) drying the separated organic fibers;
(7) measuring fiber length of the dried respective organic fibers; and
(8) calculating number-average length based on the each fiber length measured.

### [Resin Molded Article]

The process of the present invention comprises plasticizing step (1), injecting step (2) and pressure-holding step (3), which are explained below, respectively.

### Plasticizing Step (1)

In this step, a thermoplastic resin contained in a resin composition is melted in an injection molding machine, thereby fluidizing the resin composition. A screw in the injection molding machine is rotated at a rotation speed of preferably 10 to 300 rpm, and more preferably 50 to 200 rpm, in order to apply a shear force to the resin composition to promote organic fiber dispersion. This process is carried out under back pressure of usually 1 MPa or higher, and preferably 5 MPa or higher, in order to promote the above-mentioned “shear of the resin composition” and “organic fiber dispersion”. Plasticizing temperature in step (1) is not particularly limited, and is higher than melting temperature of the thermoplastic resin, and lower than melting temperature of the organic fiber, and is preferably 170 to 260° C., and more preferably 180 to 230° C. A plasticizing time in step (1) is preferably 10 minutes or less, and more preferably 5 minutes or less, in order to (i) inhibit degradation of the organic fiber and thermoplastic resin, and (ii) decrease a molding cycle time.

### Injecting Step (2)

The above plasticized resin composition is pressed into a mold cavity under injection pressure of the injection molding machine. Step (2) is carried out by moving forward the screw of the injection molding machine, at an injection speed (forward speed of the screw) of preferably 1 to 1,000 mm/second, and more preferably 10 to 1,000 mm/second, in order to obtain a resin molded article excellent in its appearance. It is preferable to preheat the mold at preferably 10 to 100° C., and more preferably 20 to 80° C., in order to obtain a resin molded article excellent in its appearance configuration.

### Pressure-Holding Step (3)

In step (3), the resin composition in the mold cavity is held under specific holding-pressure for a specific time. Step (3) is carried out by further moving forward the screw of the injection molding machine. The above specific holding-pressure in the present invention is 70 to 300 MPa, preferably 80 to 250 MPa, and further preferably 100 to 200 MPa, in order to increase impact strength of a resin molded article obtained. The above specific time (pressure-holding time) in the present invention is 0.5 to 60 seconds, and preferably 1 to 50 seconds. When the time is less than 0.5 second, a resin molded article may be unsatisfactory in its impact strength. The time of more than 60 seconds may be unfavorable for a molding cycle time. The mold in this step has temperature of preferably to 100° C., and more preferably 20 to 80° C. The holding-pressure depends on a type of a resin molded article, and is measured with a pressure gauge installed in an injection molding machine.

Organic fibers contained in a resin molded article produced by the process of the present invention has number-average length of preferably 1 to 50 mm, more preferably 3 to 20 mm, and further preferably 5 to 15 mm, from a viewpoint of mechanical strength such as impact strength of the resin molded article, and appearance thereof. The resin molded article in the present invention can be used for various purposes, such as a car interior part, an engine room part, a car exterior part, an electric instrument part, a machinery part, and a building material.

### EXAMPLE

The present invention is explained with reference to the following Example, which does not limit the present invention.

### Example 1

### (1) Starting Materials

### (1-1) Organic Fiber

There was used a polyethylene terephthalate continuous fiber manufactured by TEIJIN FIBERS LTD., (i) having a fiber diameter of 35 μm, single yarn fineness of 13 dtex, and 2.0% by weight of a polyurethane resin (binder) on its surface, and (ii) produced by melt-spinning a polyethylene-2,6-naphthalate chip having intrinsic viscosity of 0.62 dL/g.

### (1-2) Thermoplastic Resin

There was used NOBLENE AU161C (trade name of propylene block copolymer manufactured by Sumitomo Chemical Co. Ltd.), (i) having a melt flow rate of 90 g/10 minutes measured at 230° C. under a load of 21.2 N, and (ii) produced by polymerizing ethylene with propylene in the presence of a propylene homopolymer, similarly to the above-exemplified “propylene block copolymer”.

### (1-3) Modifier

### (1-3-1) Modified Polyolefin Resin-1

There was used a maleic anhydride-modified polypropylene rein, (i) having a melt flow rate of 70 g/10 minutes measured at 230° C. under a load of 21.2 N, and a maleic anhydride-grafting amount of 0.6% by weight, and (ii) produced by a method disclosed in Example 1 of JP 2004-197068A.

### (1-3-2) Modified Polyolefin Resin-2

There was used BONDFAST CG5001 (trade name of ethylene-glycidyl methacrylate copolymer manufactured by Sumitomo Chemical Co. Ltd.), having a melt flow rate of 380 g/10 minutes measured at 190° C. under a load of 21.2 N, and 19% by weight of glycidyl methacrylate polymerization units.

### (2) Resin Composition

A resin composition having a pellet-shape was produced by a method comprising steps of:
(1) impregnating the above organic fiber with a melted resin mixture (its temperature: about 200° C.) supplied from an extruder continuously to a crosshead die having a wavy surface, according to a pultrusion method disclosed in JP 3-121146A, wherein (1-1) the organic fiber was pulled continuously through the crosshead die, and (1-2) the melted resin mixture contained the above thermoplastic resin, modified polyolefin resin-1 and modified polyolefin resin-2;
(2) pulling the impregnated organic fiber continuously through a shaping die at a pulling speed of 13 m/second, thereby forming a strand of the impregnated organic fiber; and
(3) cutting the strand, thereby obtaining a resin composition pellet.

The obtained pellet was 11 mm in its length, and was found to contain 30.0% by weight of the organic fiber, 66.5% by weight of the thermoplastic resin, 2.7% by weight of modified polyolefin resin-1, and 0.8% by weight of modified polyolefin resin-2, the total of the organic fiber, the thermoplastic resin, modified polyolefin resin-1 and modified polyolefin resin-2 being 100% by weight.

### (3) Resin Molded Article

The above pellet was injection-molded with an injection-molding machine, SE130DU (trade name of Sumitomo Heavy Industries, Ltd.), having clamping pressure of 130 tons, maximum holding-pressure of 135 MPa, and a screw diameter of mm, under following molding conditions: cylinder temperature of 200° C., mold temperature of 50° C., injection speed of 34 mm/second, holding-pressure of 130 MPa (96% of maximum holding-pressure, 135 MPa), and pressure-holding time of 5 seconds, thereby obtaining a flat resin plate having a size of 100 mm×400 mm×3 mm (thickness).

A test piece for measuring impact strength was made from the above flat resin plate by a method comprising steps of:
(i) cutting off each of its opposite sides by 50 mm, thereby obtaining a plate having a size of 100 mm×300 mm×3 mm (thickness); and
(ii) cutting out the obtained plate, thereby obtaining a test piece having a size of 100 mm×100 mm×3 mm (thickness).

The test piece was found to have impact strength of 18.5 J. Results are summarized in Table 1.

The above impact strength was measured with the use of HIGH RATE IMPACT TESTER (trade name of Reometrics, Inc.) by a method comprising steps of:
(1) fixing the test piece by sandwiching the test piece between two ring-shaped plates, each plate having a 2 inch-diameter hole in its center;
(2) hitting a dart equipped with a censer to the fixed test piece at a constant speed, thereby penetrating (breaking) the test piece with the dart;
(3) measuring a displacement of the test piece and a load received by the test piece with the censer, thereby obtaining a displacement-load curve; and
(4) calculating impact strength (breaking energy) of the test piece from the displacement-load curve.

### Comparative Examples 1 to 5

Example 1 was repeated except that (1) the holding-pressure of 130 MPa and/or (2) the pressure-holding time of 5 seconds were changed, respectively, as shown in Table 1. Results are summarized in Table 1.

TABLE 1

| | | Comparative Example | | | | |
|---|---|---|---|---|---|---|
| | Example 1 | 1 | 2 | 3 | 4 | 5 |
| Molding condition | | | | | | |
| (1) Holding-pressure (MPa) | 130 | 0 | 14 | 27 | 41 | 68 |
| (2) Pressure-holding time (second) | 5 | 0 | 5 | 5 | 5 | 5 |
| Impact strength (J) | 18.5 | 17.2 | 16.7 | 17.2 | 16.8 | 17.3 |

1. A process for producing a resin molded article, comprising steps of:
(1) plasticizing a resin composition containing an organic fiber and a thermoplastic resin with an injection-molding machine;
(2) injecting the plasticized resin composition into a mold cavity of the injection-molding machine; and
(3) pressure-holding against the resin composition in the mold cavity for a pressure-holding time of 0.5 to 60 seconds under holding-pressure of 70 to 300 MPa.

2. The process according to claim 1, wherein the organic fiber contained in the resin composition in step (1) has number-average fiber length of 1 to 50 mm.

3. The process according to claim 1, wherein the resin composition in step (1) is a pellet having longitudinal length equal to number-average length of the organic fiber contained in the pellet.

4. The process according to claim 1, wherein the resin composition contains 1 to 70% by weight of the organic fiber and 30 to 99% by weight of the thermoplastic resin, provided that the total of the organic fiber and the thermoplastic resin is 100% by weight.
